(19) United States
(12) Patent Application Publication
(10) Pub. No.: US 2015/0368124 A1
(43) Pub. Date: Dec. 24, 2015

(54) Water Processing Device

(71) Applicant: Tsai-Chun Hsu, Taoyuan County (TW)

(72) Inventor: Tsai-Chun Hsu, Taoyuan County (TW)

(21) Appl. No.: 14/312,751

(22) Filed: Jun. 24, 2014

(51) Int. Cl. C02F 1/467

(52) U.S. Cl. CPC C02F 1/4674; C02F 2305/02; C02F 2201/461; C02F 2303/04

(57) ABSTRACT

A water processing device includes a main pipe having a water inlet, a water outlet, a first port, and a second port. The water inlet is connected to a water source. The first port and the second port are located between the water inlet and the water outlet, with the first port located between the second port and the water inlet, and with the second port located between the first port and the water outlet. A sodium chloride supply module is mounted to the first port for supplying sodium chloride into an interior of the main pipe via the first port. The sodium chloride dissolves in the water in the main pipe. An electrolyzing module is mounted to the second port for electrolyzing the water containing sodium chloride to generate hypochlorous acid water to be outputted via the water outlet.

### BACKGROUND OF THE INVENTION

1. Field of the Invention

The present invention relates to a water processing device and, more particularly, to a water processing device for disinfecting water.

2. Description of the Related Art

For the present, water used in daily lives, such as water used in kitchens, laundry, and toilets, is tap water or underground water. Such water does not provide a disinfectant effect even if it has been purified. Thus, an object washed by such water requires an additional disinfecting process (such as sterilizing tableware by high-temperature water or an ultraviolet sterilizer after washing) or adding a disinfectant while using the water (such as adding a disinfectant in the laundry water or a water tank of a toilet).

Regarding water used in kitchens, disinfection by either high-temperature water or an ultraviolet sterilizer can not be carried out while washing objects. Thus, the whole process from washing through disinfection is time consuming, and use of pots having a large volume is not suitable. Regarding water for laundry and toilets, the disinfectant must be added during use (the disinfecting effect is not provided if the disinfectant is not added), which is inconvenient to use. Improvement is, thus, necessary.

### SUMMARY OF THE INVENTION

An objective of the present invention is to provide a water processing device connected to a water source such that water flowing through the water processing device is turned into hypochlorous acid (HClO) water before use.

The present invention fulfills the above objective by providing a water processing device including a main pipe having an interior. The main pipe includes a water inlet, a water outlet, a first port, and a second port. The water inlet, the water outlet, the first port, and the second port are in communication with the interior of the main pipe. The water inlet is adapted to be connected to a water source and adapted to guide water to flow into the interior of the main pipe and to flow toward the water outlet. The first port and the second port are located between the water inlet and the water outlet, with the first port located between the second port and the water inlet, and with the second port located between the first port and the water outlet. A sodium chloride supply module is mounted to the first port. The sodium chloride supply module is adapted to supply sodium chloride into the interior of the main pipe via the first port. The sodium chloride is adapted to dissolve in the water in the main pipe. An electrolyzing module is mounted to the second port. The electrolyzing module is adapted to electrolyze the water containing sodium chloride to generate hypochlorous acid water. Hypochlorous acid water is adapted to be outputted via the water outlet.

In an embodiment, the sodium chloride supply module includes a sodium chloride supply pipe, a sodium chloride storage tank, and a valve. The sodium chloride supply pipe includes a first end in communication with the interior of the main pipe via the first port and a second end. The sodium chloride storage tank is mounted to the second end of the sodium chloride supply pipe. The valve is mounted between the first and second ends of the sodium chloride supply pipe.

In an embodiment, the electrolyzing module includes a base, a power supply, and two electrodes. The base seals the second port of the main pipe. The power supply is mounted to the base. Each electrode extends through the base. Each electrode includes a first end exposed outside of the base and electrically connected to the power supply.

In an embodiment, the electrolyzing module further includes a branch pipe having an end in communication with the interior of the main pipe via the second port. The other end of the branch pipe is sealed by the base. Each electrode includes a second end extending in the branch pipe. Gaseous chlorine is adapted to be generated at one of the electrodes after electrolysis. Gaseous chlorine is adapted to combine with the water in the main pipe to form hypochlorous acid water. Gaseous hydrogen is adapted to be generated at the other electrode after electrolysis.

In another example, the second end of each electrode extends into the interior of the main pipe.

In an embodiment, the electrolyzing module further includes a ventilation pipe and a ventilation valve. The ventilation pipe is mounted to the branch pipe or the base and is in communication with an interior of the branch pipe. The ventilation valve is mounted to the ventilation pipe. Gaseous hydrogen generated at the other electrode is adapted to be discharged via the ventilation pipe and the ventilation valve. The ventilation valve is adapted to permit flow of gas but do not permit flow of liquid.

A protective housing can be mounted to the branch pipe or the base. The protective housing receives the power supply and the first ends of the electrodes exposed outside of the base.

In an embodiment, the ventilation pipe is received in the protective housing. The protective housing includes a through-hole in communication with an outside. Gaseous hydrogen generated at the other electrode is adapted to flow to the outside via the through-hole.

In an embodiment, one of the electrodes is made of carbon and is electrically connected to a positive pole of the power supply. The other electrode is made of alloy steel and is electrically connected to a negative pole of the power supply.

In an embodiment, a valve is mounted between the second port and the water outlet. The valve is adapted to control output of hypochlorous acid water via the water output.

The water processing device according to the present invention can be connected to a water source to cause sodium chloride to dissolve in the water flowing through the water processing device, and hypochlorous acid water with a disinfectant effect can be generated after electrolysis before output for direct use in washing objects while providing a disinfecting effect. The time required from washing through disinfecting is effectively reduced, and the use convenience is significantly improved.

The present invention will become clearer in light of the following detailed description of illustrative embodiments of this invention described in connection with the drawings.

### BRIEF DESCRIPTION OF THE DRAWINGS

The illustrative embodiments may best be described by reference to the accompanying drawings where:

FIG. 1 is a diagrammatic view of a water processing device of an embodiment according to the present invention, with a portion of the water processing device cross sectioned.

FIG. 2 is a view similar to FIG. 1, illustrating operation of the water processing device.

### DETAILED DESCRIPTION OF THE INVENTION

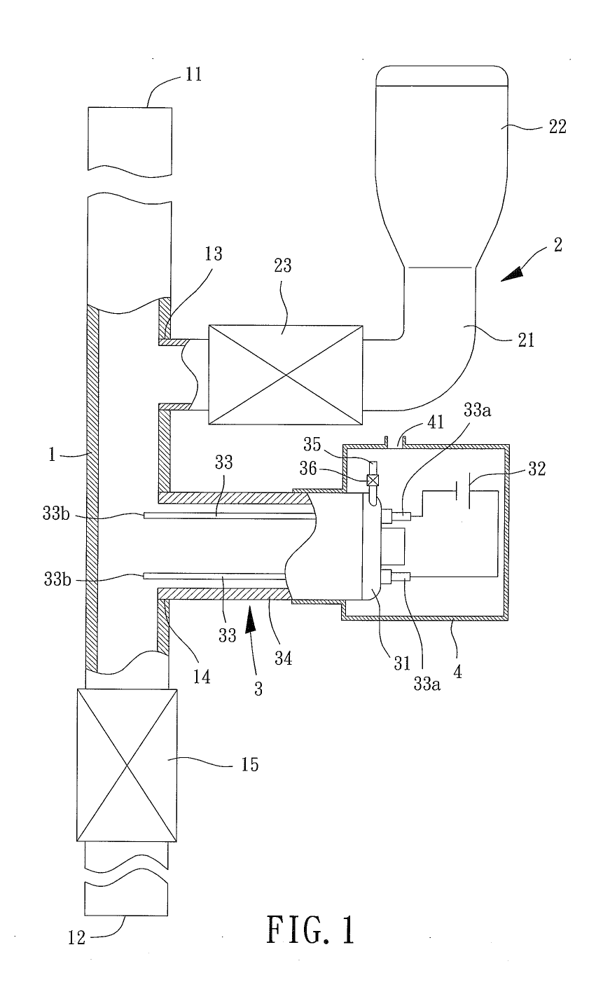

With reference to FIG. 1, a water processing device of an embodiment according to the present invention includes a main pipe 1, a sodium chloride supply module 2, and an electrolyzing module 3. The sodium chloride supply module 2 and the electrolyzing module 3 are mounted to the main pipe 1. The sodium chloride supply module 2 supplies sodium chloride into water flowing through an interior of the main pipe 1. The electrolyzing module 3 electrolyzes the water containing sodium chloride.

The main pipe 1 includes a water inlet 11 and a water outlet 12. The water inlet 11 is adapted to be connected to a water source and is adapted to guide water to flow into the interior of the main pipe 1 and to flow toward the water outlet 12. The main pipe 1 further includes a first port 13 and a second port 14. The first port 13 and the second port 14 are located between the water inlet 11 and the water outlet 12, with the first port 13 located between the second port 14 and the water inlet 11, and with the second port 14 located between the first port 13 and the water outlet 12. A valve 15 can be mounted between the second port 14 and the water outlet 12. The valve 15 is adapted to control output of water via the water output 12.

The sodium chloride supply module 2 is mounted to the first port 13 of the main pipe 1. The sodium chloride supply module 2 includes a sodium chloride supply pipe 21 directly or indirectly connected to the first port 13 of the main pipe 1. As an example, a first end of the sodium chloride supply pipe 21 is received in the first port 13 of the main pipe 1 such that an interior of the sodium chloride supply pipe 21 is in communication with the interior of the main pipe 1. In this embodiment, a sodium chloride storage tank 22 is mounted to a second end of the sodium chloride supply pipe 21. The sodium chloride storage tank 22 can receive liquid or solid sodium chloride (preferably sodium chloride particles or sodium chloride powders) to supply sodium chloride into the interior of the main pipe 1. A valve 23 can be mounted between the first and second ends of the sodium chloride supply pipe 21 to control the quantity and timing for feeding sodium chloride into the main pipe 1.

The electrolyzing module 3 is mounted to the second port 14. The electrolyzing module 3 includes a base 31, a power supply 32, and two electrodes 33. The base 31 seals the second port 14 of the main pipe 1. The power supply 32 is mounted to the base 31. Each electrode 33 extends through the base 31. In this embodiment, a branch pipe 34 has an end connected to the main pipe 1 and is in communication with the interior of the main pipe 1 via the second port 14, and the base 31 seals the other end of the branch pipe 34. In another example, a connecting unit (not shown) can be used to connect an end of the branch pipe 34 to the main pipe 1 such that the interior of the branch pipe 34 can be in communication with the interior of the main pipe 1. Nevertheless, the base 31 can be directly mounted to the main pipe 1 to seal the second port 14.

The power supply 32 is mounted to the base 31 and can be in the form of a D.C. power source or a battery. One of the electrodes 33 is electrically connected to a positive pole of the power supply 32, and the other electrode 33 is electrically connected to a negative pole of the power supply 32. In this embodiment, the electrode 33 electrically connected to the positive pole of the power supply 32 is made of carbon, and the other electrode 33 electrically connected to the negative pole of the power supply 32 is made of alloy steel. Each electrode 33 includes a first end 33a and a second end 33b. Each electrode 33 extends through the base 31 such that the first end 33a exposed outside of the base 31 is electrically connected to the power supply 32. The second end 33b of each electrode 33 extends in the branch pipe 34. In a case that the main pipe 1 does not include the valve 15, the second end 33b of each electrode 33 preferably extends into the interior of the main pipe 1. In a case that the main pipe 1 includes the valve 15, the locations of the second ends 33b of the electrodes 33 are not limited.

The electrolyzing module 3 can further include a ventilation pipe 35 and a ventilation valve 36. The ventilation pipe 35 is mounted to the branch pipe 34 or the base 31 to be in communication with the interior of the branch pipe 34. The ventilation valve 36 is mounted to the ventilation pipe 35. The ventilation valve 36 permits flow of gas but does not permit flow of liquid.

The water processing device can further include a protective housing 4 mounted to the branch pipe 34 or the base 31 and located outside of the base 31. The protective housing 4 receives the power supply 32 and the first ends 33a of the electrodes 33 exposed outside of the base 31, protecting the power supply 32 and the first ends 33a of the electrodes 33 from impacting, pulling, and moisture to thereby prolong their service lives while providing a neat, tidy appearance for the water processing device. In a case that the ventilation pipe 35 is also received in the protective housing 4, the protective housing 4 includes a through-hole 41 in communication with the outside, such that gas can flow between the through-hole 41 and the ventilation pipe 35.

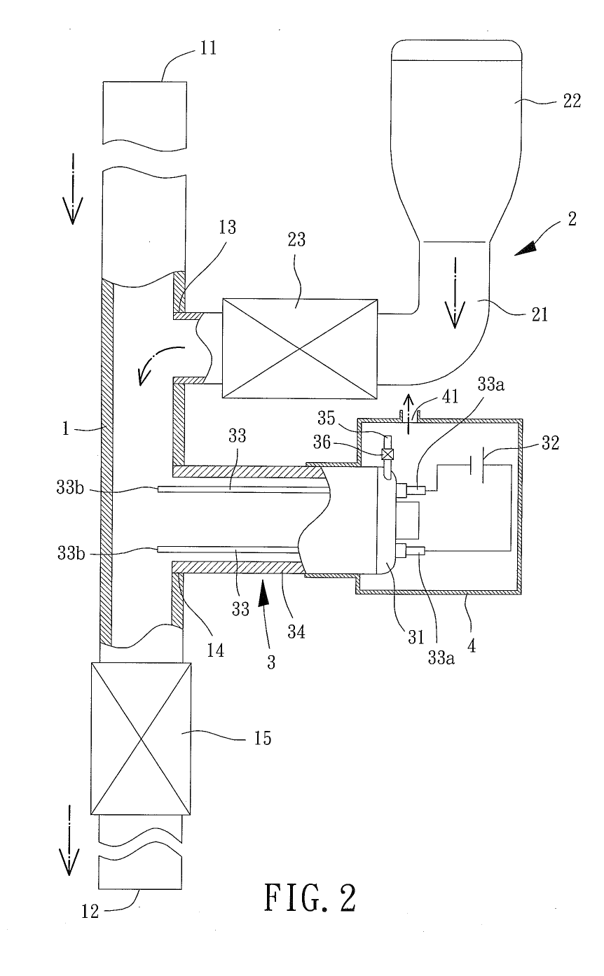

With reference to FIG. 2, in operation of the water processing device of the embodiment according to the present invention, the valve 15 of the main pipe 1 is firstly closed such that water entering the interior of the main pipe 1 via the first port 13 accumulates in the main pipe 1. At the same time, the valve 23 of the sodium chloride supply module 2 is open, and a negative pressure is created while water flows. Thus, when the water flows through the first port 13, sodium chloride in the sodium chloride supply pipe 21 is sucked into the main pipe 1 and dissolves in the water in the main pipe 1.

Then, the water containing sodium chloride is electrolyzed by the electrodes 33 of the electrolyzing module 3. Gaseous chlorine is generated at one of the electrodes 33 after electrolysis (the chemical equation is: 2Cl⁻→Cl₂+2e⁻). Gaseous chlorine combines with the water in the main pipe 1 to form hypochlorous acid water (the chemical equation is: Cl₂+H₂O→H⁺+Cl⁻HClO). Hypochlorous acid (HCLO) water with a disinfectant effect is, thus, produced. Gaseous hydrogen is generated at the other electrode 33 after electrolysis (the chemical equation is: 2Na⁺+2H₂O+2e⁻→2NaOH+H₂ ↑). Gaseous hydrogen is discharged via the ventilation pipe 35 and the ventilation valve 36. Then, the valve 15 of the main pipe 1 can be opened such that disinfectant hypochlorous acid (HClO) water can flow out of the water outlet 12 of the main pipe 1 for use in laundry, washing dishes, or flushing toilets, directly disinfecting clothes, tableware, and toilets, which is extremely convenient.

In the case that main pipe 1 does not include the valve 15, although the water flowing through the main pipe 1 via the water inlet 1 cannot accumulate in the main pipe 1, sodium chloride can still dissolve in the water passing through the first port 13. Thus, when the water containing sodium chloride flows through the second port 14, the second ends 33b of the electrodes 33 extending into the interior of the main pipe 1 can electrolyze the water contacting sodium chloride to generate hypochlorous acid water with a disinfectant effect.

In view of the foregoing, the water processing device according to the present invention can be connected to a water source to cause sodium chloride to dissolve in the water flowing through the water processing device, and hypochlorous acid water with a disinfectant effect can be generated after electrolysis before output for direct use in washing objects while providing a disinfecting effect. The time required from washing through disinfecting is effectively reduced, and the use convenience is significantly improved.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A water processing device comprising:
a main pipe including an interior, with the main pipe including a water inlet, a water outlet, a first port, and a second port, with the water inlet, the water outlet, the first port, and the second port in communication with the interior of the main pipe, with the water inlet adapted to be connected to a water source and adapted to guide water to flow into the interior of the main pipe and to flow toward the water outlet, with the first port and the second port located between the water inlet and the water outlet, with the first port located between the second port and the water inlet, and with the second port located between the first port and the water outlet;
a sodium chloride supply module mounted to the first port, with the sodium chloride supply module adapted to supply sodium chloride into the interior of the main pipe via the first port, with the sodium chloride adapted to dissolve in the water in the main pipe; and
an electrolyzing module mounted to the second port, with the electrolyzing module adapted to electrolyze the water containing sodium chloride to generate hypochlorous acid water, and with hypochlorous acid water adapted to be outputted via the water outlet.

2. The water processing device as claimed in claim 1, with the sodium chloride supply module including a sodium chloride supply pipe, a sodium chloride storage tank, and a valve, with the sodium chloride supply pipe including a first end in communication with the interior of the main pipe via the first port and a second end, with the sodium chloride storage tank mounted to the second end of the sodium chloride supply pipe, and with the valve mounted between the first and second ends of the sodium chloride supply pipe.

3. The water processing device as claimed in claim 1, with the electrolyzing module including a base, a power supply, and two electrodes, with the base sealing the second port of the main pipe, with the power supply mounted to the base, with each of the two electrodes extending through the base, and with each of the two electrodes including a first end exposed outside of the base and electrically connected to the power supply.

4. The water processing device as claimed in claim 3, with the electrolyzing module further including a branch pipe having an end in communication with the interior of the main pipe via the second port, with the branch pipe including another end sealed by the base, with each of the two electrodes including a second end extending in the branch pipe, with gaseous chlorine adapted to be generated at one of the two electrodes after electrolysis, with gaseous chlorine adapted to combine with the water in the main pipe to form hypochlorous acid water, and with gaseous hydrogen adapted to be generated at another of the two electrodes after electrolysis.

5. The water processing device as claimed in claim 4, with the second end of each of the two electrodes extending into the interior of the main pipe.

6. The water processing device as claimed in claim 4, with the electrolyzing module further including a ventilation pipe and a ventilation valve, with the ventilation pipe mounted to the branch pipe or the base and in communication with an interior of the branch pipe, with the ventilation valve mounted to the ventilation pipe, with gaseous hydrogen generated at the other electrode adapted to be discharged via the ventilation pipe and the ventilation valve, and with the ventilation valve adapted to permit flow of gas but do not permit flow of liquid.

7. The water processing device as claimed in claim 6, further comprising: a protective housing mounted to the branch pipe or the base, with the protective housing receiving the power supply and the first ends of the two electrodes exposed outside of the base.

8. The water processing device as claimed in claim 7, with the ventilation pipe received in the protective housing, with the protective housing including a through-hole in communication with an outside, and with gaseous hydrogen generated at the other electrode adapted to flow to the outside via the through-hole.

9. The water processing device as claimed in claim 3, with one of the two electrodes made of carbon and electrically connected to a positive pole of the power supply, with another of the two electrodes made of alloy steel and electrically connected to a negative pole of the power supply.

10. The water processing device as claimed in claim 1, further comprising: a valve mounted between the second port and the water outlet, with the valve adapted to control output of hypochlorous acid water via the water output.
